(19) United States
(12) Patent Application Publication
(10) Pub. No.: US 2016/0200610 A1
(43) Pub. Date: Jul. 14, 2016

(54) Cost Optimized System for WWTP Using Lagoons and In-Situ Membrane Bio Reactor Modules

(71) Applicant: James Philip Reilly, Vancouver, WA (US)

(72) Inventor: James Philip Reilly, Vancouver, WA (US)

(21) Appl. No.: 14/594,571

(22) Filed: Jan. 12, 2015

(51) Int. Cl. C02F 3/12

(52) U.S. Cl. CPC C02F 3/1268; C02F 2209/40; C02F 2203/006

(57) ABSTRACT

This patent describes a system to fitter wastewater that does not require any container vessels or other traditional wastewater treatment plant (WWTP) utilities. By employing a floatable platform in conjunction with structural members to contain and manage flat sheet membranes (MBR) this new implementation of MBR technology removes virtually all requirements for hardware and software systems to manage the operations on a day-to-day basis while at the same time eliminating all risks of underflow, overflow or any other leakage type faults. As a consequence this system cannot only be managed without day-to-day supervision but in theory could be scaled at infinitum.

Existing lagoon or facultative lagoon based wastewater treatment plant (WWTP) systems typically consist of one or more ponds where wastewater influent is processed. In these systems the removal rate of waste products is typically no more than 70%. As a consequence these systems are being phased out in the USA with new, expensive activated sludge or other secondary treatment systems. Not only are the new systems expensive but also decommissioning of lagoons is typically required in order to make regulatory water permit requirements. This proposed In Situ treatment system not only eliminates the requirement for other secondary treatment upgrades but also eliminates the need for decommissioning these same lagoons. Furthermore such in situ treatment is substantially lower cost than modular membrane pretreatment while adding additional reliability.

Membrane-Bio-Reactor (MBR) treatment systems are secondary WWTP treatment systems that historically have been used to produce very high quality effluent (98% or greater contaminants removal). The problem with these systems, however are several fold.
MBRs typically are relatively expensive to install costing $20 per gallon capacity of infrastructure/capital costs.
MBR systems tend to utilize more power than other alternatives
MBR systems can be challenging to keep operational with normal parameters
MBR systems have historically not handled peak demand flows that are greater than 2× normal flows.

The recent introduction of Modular MBR systems has substantially lowered operational and capital costs but has done little to address peak demand and day to day operational challenges. A solution to both of these problems that also addresses the poor effluent quality coming from lagoon-based systems is to utilize a modular MBR system in conjunction with a lagoon-based WWTP. A superior approach to this MBR/Lagoon dual treatment is to place MBR units directly into the lagoon for treatment.

Additionally it has been observed that lagoons have a clarification effect where water with more contaminants sinks while cleaner water tends to rise to the top of the water column. Because of this phenomena it has been observed that there is no need for a separate modular system to pre-treat lagoons but instead a system for placing the MBR units directly in the lagoon will work as well or better while at the same time reducing cost, complexity and eliminating the need for load balancing, level management and peak demand overflow management.

Finally a separate module is both expensive and unnecessary when utilizing membranes in situ and also presents additional structural and overflow risk that become irrelevant when processing wastewater directly in the lagoon.

### Key Benefits

This MBR within a lagoon solution has several important benefits:

After less than 3 weeks of using MBR systems in lagoons can replace enough water to bring most typical lagoons into 85% removal compliance. Over time these same lagoons are reconstituted to store clean uncontaminated water that can act as a dilution buffer zone during high flow events.

Most MBR and other systems will use equalization (EQ) basins to handle excess flows during peak times. The problem with EQ basins is that when they are used they act as solids collection systems that must be periodically cleaned. Furthermore if there is a very high storm event they can overflow, spilling 100 percent untreated influent into discharge points. In many cases this overflow phenomenon can typically wash out the biology of an entire WWTP which can take weeks or months to fully recover. Finally on low flow days, these tanks can produce odor that, to be addressed requires additional aeration which can add to costs.

In this situation these lagoons will act like a capacitor providing a large buffer that can absorb this untreated overflow.

In situ MBR units are virtually self-running and need no day-to-day or week-to-week maintenance. They also completely eliminate the need for water level management (both low level and high level) and also eliminate the need for any recovery or emergency overflow piping or electronic logic.

In situ MBR units will continually clean the water in a lagoon system which means that at any given time the water in the lagoon will be on average 99% clean. This means that any failure of the system can be ignored for up to one month or greater without risk of violating typical 85% removal permit requirements. As a direct consequence no redundant WWTP capabilities (including additional membrane units, power back-up generators, cameras, warning systems and other alerts) are necessary. The broken system can simply be repaired in due course when it is observed to be out of service by the individual who collects influent and effluent test samples on a weekly basis.

By placing MBR units within the lagoon there are substantial cost savings for liquid storage and containment. Modular WWTP systems require substantial investment to insure that all liquid containers are watertight, structurally robust and meet transportation restrictions. These costs combined with the additional electronic and mechanical components to ensure these modular units will not over/under flow are completely unnecessary in an in-situ-based MBR lagoon combination. This is due to the fact that the lagoon itself provides both structural and level management implicitly.

An MBR system in situ in a lagoon system therefore will provide the best of both worlds. A system that can provide extremely high quality effluent most days, but in the event of any MBR problems, the system can still remain within permit requirements until it is repaired.

This application includes the following list of figures:

1. MBR System Raft Section View with Cutaway

2. MBR System Raft Isometric View with Cutaway Underside of Raft Facing Upwards

3. MBR System Raft Isometric View with Cutaway

4. MBR System Raft Isometric View

5. MBR System Raft Plan View with Cutaway

6. MBR System Raft Section B View with Cutaway

7. MBR System Raft Section B View

### BRIEF DESCRIPTION OF THE DRAWINGS

FIG. 1 shows a cross-section of the floatable RAFT FRAME sitting in water with the MBR UNITS suspended below the water surface.

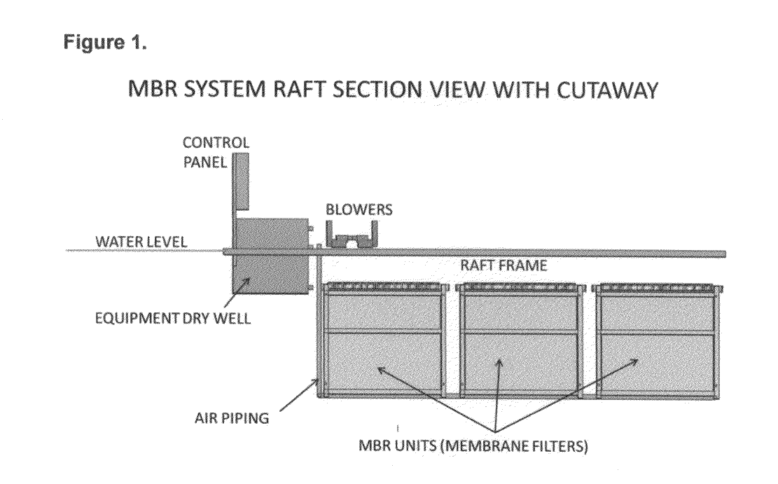

FIG. 2 shows the floatable RAFT FRAME from below the water surface. From this isometric view one can see the bottom side of the MBR UNITS and EQUIPMENT DRY WELL.

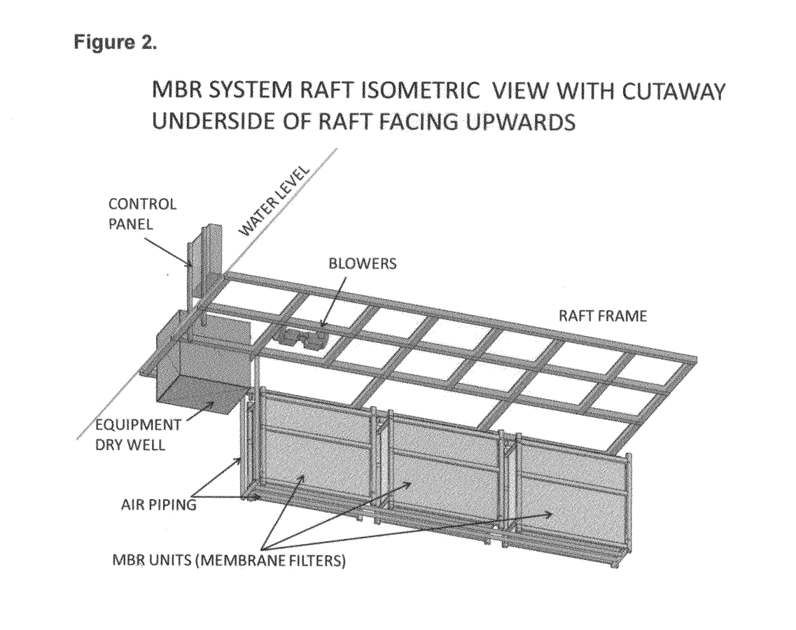

FIG. 3 shows an isometric view of the floatable RAFT FRAME from above, with the RAFT FRAME walking surface cut away to show the MBR UNITS below.

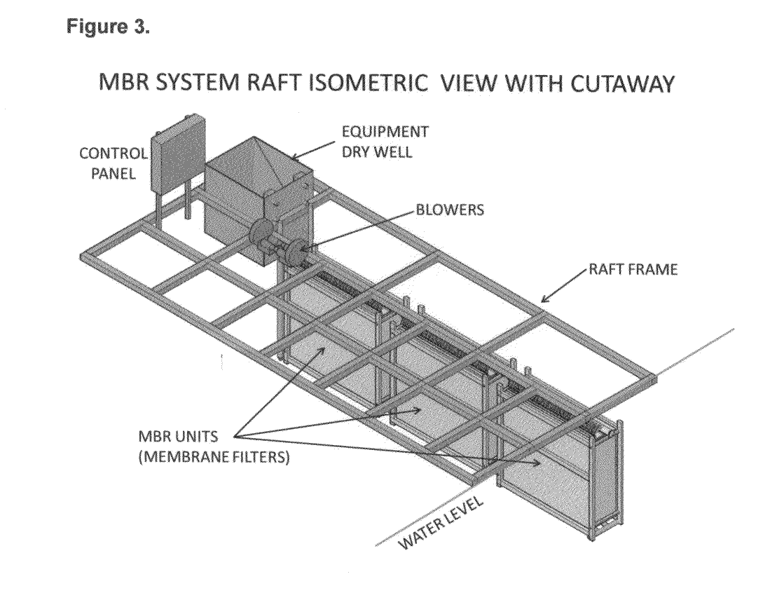

FIG. 4 shows an isometric view of the floatable RAFT FRAME from above, with the RAFT SURFACE intact.

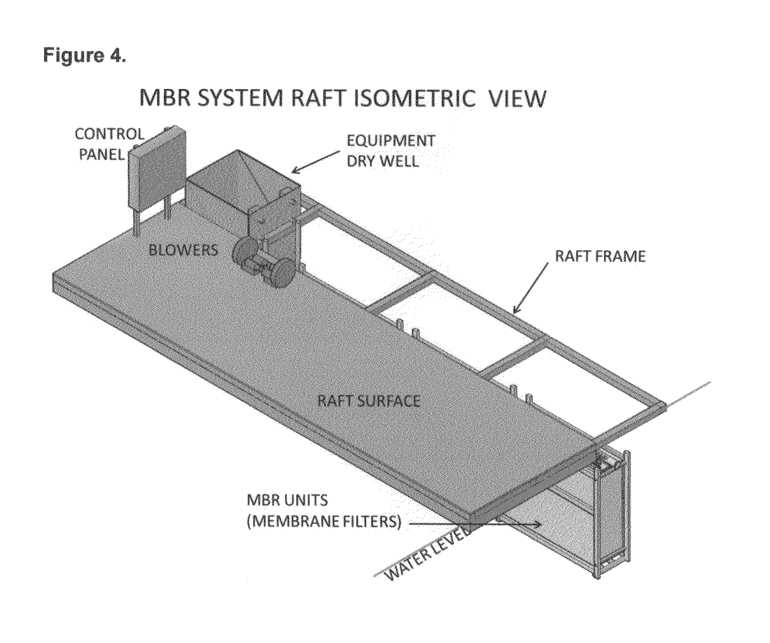

FIG. 5 shows the plan view of the floatable RAFT FRAME from above, with the RAFT SURFACE cut away to show the RAFT FRAME below. A section cut line of Section B is shown and Section B perspective is provided in FIGS. 6 and 7.

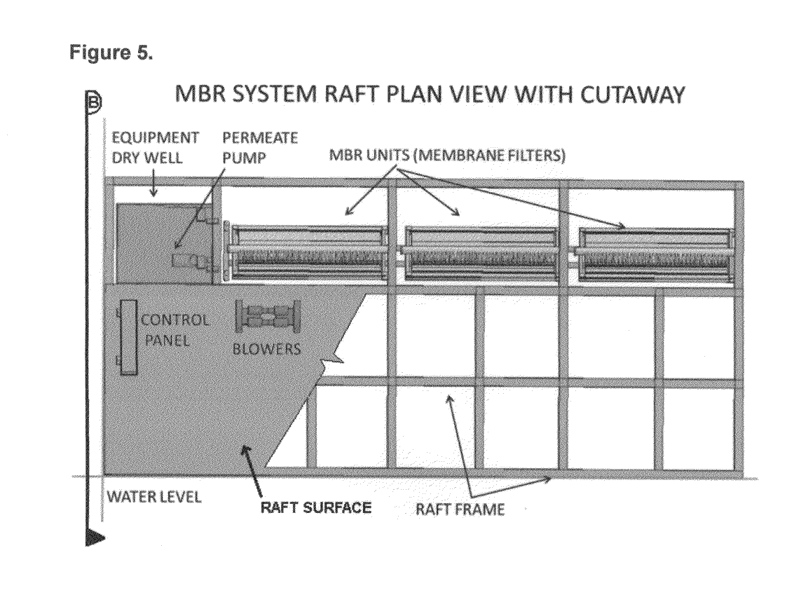

FIG. 6 shows Section B isometric view of the floatable RAFT FRAME, EQUIPMENT DRY WELL, MBR UNITS, AIR PIPING, BLOWERS, and CONTROL PANEL.

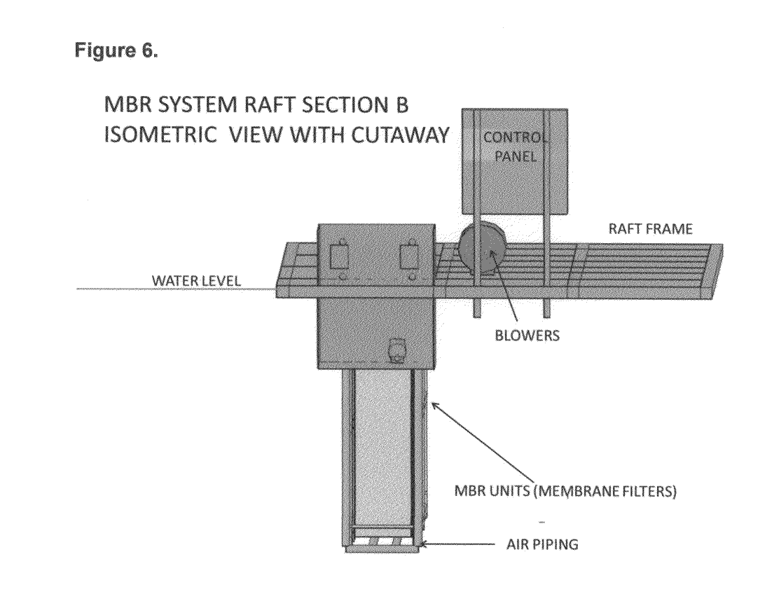

FIG. 7 shows the same in a straight on section view.

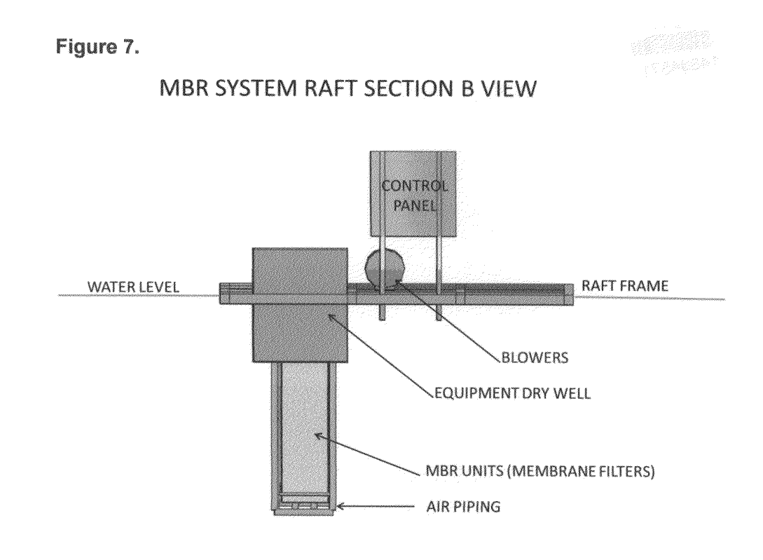

1. An apparatus comprising:
a container consistent with an International Organization for Standardization (ISO) specification for intermodal containers;
a basin included in the container, the basin to include a base and a plurality of side walls;
a corrosion resistant liner coupled to interior portions of each of the base and side walls of the basin;
an inlet to receive wastewater treatment process material into the basin;
a weir disposed within the basin to form a first basin compartment including the inlet, and a second basin compartment, the weir to control the flow of the wastewater treatment process material from the first basin compartment to the second basin compartment; and
an outlet to output wastewater treatment process material from the basin.

2. The apparatus of claim 1, wherein the outlet is included in the second basin compartment.

3. The apparatus of claim 1, wherein the weir comprises an overflow barrier having a height less than a height of the basin, the weir to form a controlled waterfall to flow from the first basin compartment to the second basin compartment.

4. The apparatus of claim 1, wherein the weir comprises a modified pipe weir.

5. The apparatus of claim 1, wherein the weir comprises an interior basin wall having at least one perforation for the wastewater treatment process material to flow from the first basin compartment to the second basin compartment.

6. The apparatus of claim 1, wherein the weir is disposed relatively perpendicular to the base of the basin.

7. The apparatus of claim 1, wherein the weir is disposed offset from perpendicular to the base of the basin.

8. The apparatus of claim 1, the first basin compartment to execute a first wastewater treatment process, and the second basin compartment to execute a second wastewater treatment process different than the first wastewater treatment process.

9. A system comprising of:
an inlet to receive wastewater influent;
an outlet to emit processed wastewater effluent; and
a container consistent with an International Organization for Standardization (ISO) specification for intermodal containers, the container to include:
a basin having a base and a plurality of side walls;
a corrosion resistant liner coupled to interior portions of each of the base and side walls of the basin;
an inlet to receive the wastewater influent into the basin; and
a weir disposed within the basin to form a first basin compartment including the inlet, and a second basin compartment, the weir to control the flow of the wastewater influent from the first basin compartment to the second basin compartment.

10. The system of claim 9, wherein the outlet is included in the second basin compartment.

11. The system of claim 9, wherein the weir comprises an overflow barrier having a height less than a height of the basin, the weir to form a controlled waterfall to flow from the first basin compartment to the second basin compartment.

12. The system of claim 9, wherein the weir comprises a modified pipe weir.

13. The system of claim 9, wherein the weir comprises an interior basin wall having at least one perforation for the wastewater influent to flow from the first basin compartment to the second basin compartment.

14. The system of claim 9, wherein the weir is disposed relatively perpendicular to the base of the basin.

15. The system of claim 9, wherein the weir is disposed offset from perpendicular to the base of the basin.

16. The system of claim 9, the first basin compartment to execute a first wastewater treatment process, and the second basin compartment to execute a second wastewater treatment process different than the first wastewater treatment process.

17. An apparatus consisting of:
a floatation device that consists of any floatable material that will provide a structure for wastewater treatment equipment from functional and structural items described in system of claims 1-16; and
a set of connections via fixed or mechanical implementations that can raise and lower said equipment of claims 1-9 into a body of water for purposes of wastewater treatment; and
a set of pipes and electrical inlets and outlets to process wastewater and dispose of it to other items described in in claims 1-16;

18. The use and the systems described in claims 1-17 in conjunction with a body of water such as a lagoon or a lake or a man-made water body for processing of wastewater along-side, within, in conjunction with, in sequence or in parallel to that water body.

19. The use and the systems described in claims 1-17 in conjunction with a traditional wastewater treatment plant along-side, within, in conjunction with, in sequence or in parallel to that treatment plant.
